(19) United States
(12) Patent Application Publication
(10) Pub. No.: US 2026/0002568 A1
(43) Pub. Date: Jan. 1, 2026

(54) DISC BRAKE AND BRAKE LINING ASSEMBLY AND LINING SPRING AND HOLD-DOWN ELEMENT THEREFOR

(71) Applicant: Haldex Aktiebolag, LANDSKRONA (SE)

(72) Inventor: Niklas Hult, Landskrona (SE)

(21) Appl. No.: 18/880,732

(22) PCT Filed: Jun. 27, 2023
(86) PCT No.: PCT/EP2023/067430

§ 371 Date: Jan. 2, 2025

(30) Foreign Application Priority Data
Jul. 5, 2022 (DE) 10 2022 116 789.5

(51) Int. Cl. F16D 65/097; F16D 55/00; F16D 55/225; F16D 127/02

(52) U.S. Cl. CPC F16D 65/0976; F16D 55/225; F16D 2055/0029; F16D 2127/02

(57) ABSTRACT

The present invention relates to a brake lining arrangement for a disc brake with a lining spring which is configured such that both a tensioning of the brake lining arrangement in a lining shaft and a return effect after brake actuation are provided.

### BACKGROUND OF THE INVENTION

The present invention relates to a disc brake, a brake lining arrangement used therein and a lining spring cooperating with the brake lining arrangement as well as a hold-down element for this lining spring.

In the case of sliding caliper brakes, the sliding caliper and the sliding brake carrier together form so-called lining shafts into which the brake linings can be loosely inserted from above through an opening in the brake caliper. The backing plates or brake lining holder plates of the brake linings are supported by their sides on generally vertical guide surfaces, the so-called horns, of the brake carrier with sufficiently large tolerances and on lower guide surfaces extending transversely to them, sliding in the axial direction. The brake pad holder plates are generally supported by leaf springs against a hold-down element in the form of a retaining bracket that can be attached to the brake caliper, i.e. without a fixed or rigid connection, which bridges the opening in the brake caliper through which the brake pad assemblies can be inserted from above, whereby these are braced against the lower guide surfaces for the purpose of proper guidance and, if necessary, vibration protection.

When the brakes are applied, the brake lining on the application side is pressed against the brake disc, while in response the opposite brake lining on the application side also comes into contact with the brake disc due to the counter-directed sliding movement of the brake caliper. At the end of the braking process, the tensioning device and the brake linings with their brake lining holder plates must be returned to their respective starting positions. While a separate return mechanism is usually provided for the tensioning device for this purpose, e.g. a return spring acting between the tensioning device and the brake caliper or a return spring already functionally integrated into the latter, independent devices have also been provided in the state of the art for the brake linings, which can act between the side wall of the brake shafts and the brake lining holder plates. These consist of differently shaped spring elements, some of which are under preload, which deform elastically during the braking stroke as a result of the relative movement between the brake lining holder plate and the shaft wall and can thus form a restoring force which comes into effect at the end of the braking process when the braking force is no longer acting, thus helping the brake lining holder plate to move back.

Examples include the spring mechanisms between the brake lining holder plate and the lateral guide surfaces of the lining shaft, as are known from EP 1 625 312 B1, DE 196 23 867 C2 or EP 2 644 926 B1. A spring element that partially surrounds the brake lining on both sides and is attached to a securing element of the brake caliper, which also serves to guide the brake lining holder plate, is known, for example, from EP 2 831 457 B1.

What all the above-mentioned devices for resetting, some of which can also serve as vibration protection, have in common is that they are very difficult to install; in particular, it is not possible to easily insert brake lining holder plates equipped with such spring mechanisms into the lining shafts from above without resistance and without obstacles. In addition, design modifications to the side walls of the lining shaft and/or the brake lining holder plate are sometimes necessary in order to enable the functionality of these spring elements in the first place, such as recesses creating undercuts, which further increase the manufacturing effort.

In order to solve such problems, separate devices are known from WO 2020/208194 A1 of the applicant, for example, which are designed in such a way that they act separately on the lower region and on the upper region of the brake lining arrangement in the context of supporting a resetting movement, whereby the mechanism provided for the lower region is fixed to the brake lining holder plate, while the mechanism provided for the upper region cooperates with the hold-down element. Nevertheless, two different spring elements are required, which increases the manufacturing costs.

Based on this, one task of the present invention is to provide a brake lining (or pad) arrangement for disc brakes and a disc brake with improved functionality in this respect. A further task is to provide a device for resetting a brake lining which is easy to mount and functionally reliable.

### SUMMARY OF THE INVENTION

In a first aspect, the invention relates to a disk brake having a brake caliper which embraces a brake disk and is slidably mounted on a brake carrier which has a lining slot for receiving and guiding a brake lining arrangement on the application side and a brake lining arrangement on the application side in an axial direction with respect to the brake disk, wherein each brake lining arrangement consists of a brake lining holder plate and a brake lining arranged thereon for contact with the brake disk, with a hold-down element which is fastened to the brake caliper and engages over an opening of the lining slot transversely to the direction of rotation of the brake disk, and with a lining spring associated with each brake lining arrangement, which bears freely with its upper end against the hold-down element and is designed in such a way that the brake lining arrangement is braced in the lining slot when the lining spring is impacted with force by the hold-down element after it has been mounted, the lining spring being fixed relative to the brake lining holder plate in the axial direction and being designed in such a way that, as a result of contact with the hold-down element, an elastic torsional deformation is induced in the lining spring, at least in sections, which causes a leverage effect acting between the hold-down element and the brake lining holder plate, which is capable of supporting a resetting of the brake lining arrangement when the brake is released.

Preferably, the lining spring is designed as a one-piece spring wire and shaped accordingly, whereby this extends over almost the entire width of the brake lining arrangement or the brake lining mounting plate.

The lining spring can have an upper transverse area with a central abutment section that comes into contact with the hold-down element and, on both sides of this, a connecting section that runs freely above the brake lining holder plate. This means that the connecting section is not in any contact with the surface of the brake lining holder plate, but spans it at a certain distance. Furthermore, each connecting section can extend into a leg, the free end of which is received in a recess provided in the brake lining holder plate.

According to the invention, the recesses are designed in such a way that they generally prevent or block movement of the free ends in the axial direction away from the brake lining holder plate. Axial direction here generally refers to the clamping direction or direction of movement of the brake lining arrangements.

In one embodiment, these recesses are formed as stepped bores or blind holes in the brake lining holder plate. In one embodiment, these recesses are formed as stepped bores or blind holes in the brake lining holder plate, whereby the diameter of the spring wire in the area of the free ends on one side and the diameter of the stepped blind hole in the area of its base on the other side are each provided with such tolerances that a slight interference fit can be formed, which holds the lining spring in the brake lining holder plate so that it cannot be lost, so that the entire brake lining arrangement can preferably be handled as an assembled kit, but nevertheless allows the lining spring to be released, i.e. pulled out, preferably manually.

In another embodiment, these recesses can be closed in the axial direction, i.e., transversely to the brake lining holder plate, by means of a clamp or the like, accommodating the free ends of the legs, which are preferably riveted to the rear of the brake lining holder plate.

This means that the free ends of the legs are not fixed in their longitudinal extension, but only their transverse movement is blocked by means of the blind holes or the clamps. For assembly purposes, when the hold-down element is removed, the lining spring can be easily inserted into the recesses by hand from above without requiring a great deal of force and can also be removed again.

The recesses in the brake lining holder plate can be easily milled or ideally taken into account during casting, as there are no undercuts. The clamps are preferably riveted to the brake lining holder plate.

Furthermore, each connecting section can be arranged offset at least in sections relative to the central abutment section and to the legs of the lining spring as viewed in the axial direction.

The central abutment section can have a U-shaped section which is exposed with respect to the hold-down element, i.e. does not come into contact with the latter, and has a transverse section to the left and right of the legs of the U-shaped section, which extends into the connecting section and, according to the invention, comes into contact in each case with an inclined surface of the hold-down element, as will be described below.

When the central abutment section, in particular the transverse sections on both sides of the U-shaped section, come into contact with the retaining bracket spanning the lining slot or the hold-down element in the mounted state of the brake lining arrangements, the lining spring is compressed in this area.

This has the effect that the lining spring exerts a certain pressure on the base of the recesses in the brake lining holder plate via its lateral legs at their free ends, so that the brake lining arrangement as a whole is braced in the lining slot in order to realize vibration-free mounting in the non-actuated state of the disc brake and perfect guidance during brake actuation.

On the other hand, according to the invention, there is a further, significant effect as a result of the tensioning of the lining spring, as this is designed and conceived with regard to its shape in such a way that an additional resetting effect occurs solely as a result of the tensioning after the brake has been applied.

In both embodiments with regard to the recesses, the fact that the free ends of the legs cannot move out in this direction due to the brackets closing the recesses in the brake lining holder plate in the axial direction or the blind holes on the one hand, and due to the special shape of the wire spring and the offset between the legs and the central abutment section on the other hand, leads to torques being induced in the connecting sections in particular or to an elastic torsional deformation being generated in the wire spring, which is quasi intrinsic, as the lining spring remains fixed in the mounted state both at its free ends and at its central abutment section. This is intrinsic, so to speak, as the lining spring remains fixed both at its free ends and at its central abutment section in the assembled state. The resulting torsional or rotational forces then cause a leverage effect in the legs, which subsequently leads to the free ends in the recesses of the brake lining holder plate exerting a force on the clamps fixed to them or on the inner wall of the blind holes.

The hold-down element according to the invention has at least one inclined surface on which one of the transverse sections of the lining spring is supported, whereby the inclination is aligned in such a way that the lining spring is compressed further downwards when the brake is applied and the brake lining arrangement is thus axially displaced. As a result, the induced torsional forces in the adjacent connecting section increase and thus the leverage effect. If braking force is no longer applied and the tensioning mechanism begins to move back to its initial position by means of a resetting device, these torsional forces suddenly take effect. As the free ends are still unable to move out in the axial direction, the leverage forces then come into play there, acting as restoring forces on the brake lining holder plate via the clamps or the inner wall of the blind holes and thus supporting a restoring movement of the entire brake lining arrangement.

In a preferred embodiment, the hold-down element has two inclination surfaces which are directed towards the brake disc in opposite directions and towards the center of the opening of the lining slot, with one inclination surface being assigned to the brake lining arrangement on the application side and one inclination surface being assigned to the brake lining arrangement on the application side in such a way that at least one transverse section of the lining spring on the application side comes into contact with the inclination surface on the application side and at least one transverse section of the lining spring on the application side comes into contact with the inclination surface on the application side.

Preferably, the inclination surface on the application side is steeper than the inclination surface on the application side, whereby the inclination surface on the application side has such an inclination that readjustment of the brake lining arrangement on the application side can always be ensured with regard to lining wear.

The two inclination surfaces, whose respective directions of inclination are aligned in opposite directions to one another, so to speak, can be provided in a central longitudinal area of the hold-down element. Preferably, these two inclination surfaces are each arranged on a wall or a fold on either side of a flat longitudinal surface of the hold-down element, which is intended in particular for the embodiment of the covering spring with a U-shaped section, which itself is then not in contact with the longitudinal surface, but only the transverse sections are in contact with the inclination surfaces. The exposed U-shaped section extends in the same direction as the connecting sections, which are offset in relation to the transverse sections in contact with the hold-down element and the legs, thereby increasing the stability of the lining spring in the assembled state, as this prevents the upper transverse section from deflecting or tilting away when the lining spring moves relative to the hold-down element. This ensures that the torsional deformation in the connecting sections required for the reset effect can occur to a sufficient extent in all cases.

In further aspects, the present invention relates to a lining spring as such with the different embodiments described above and to a hold-down element as such with the corresponding inclination surfaces.

In particular, the present invention relates to a brake lining arrangement comprising a brake lining holder plate and a brake lining arranged thereon for a disc brake comprising a lining spring according to one of the embodiments described above.

The lining spring according to the invention has the advantage that it can be manufactured using spring wire in a simple manner and therefore at low cost. Since the lining spring does not rest on the horns and/or the base surfaces of the lining slot and on the outside of the brake lining holder plate and acts directly between these, no cost-intensive shaping of these surfaces in the lining slot is necessary. The recesses in the brake lining holder plate can also be produced in a simple manner. The hold-down element with the respective inclination surfaces can be produced cost-effectively as a sheet metal part. As a result of the use of a simply designed lining spring, a simply designed hold-down element and a simply designed brake lining holder plate, both in terms of design and with regard to their interaction in functional terms, simple assembly and disassembly of the brake lining arrangement according to the invention is made possible, whereby this is designed identically for the clamping side and application side. The brake lining arrangement consisting of brake lining with brake lining holder plate and brake lining spring attached to or mounted on it can therefore be offered independently as a kit, even for retrofitting purposes, and can be handled manually.

### BRIEF DESCRIPTION OF THE DRAWINGS

Further features and advantages of the invention are apparent from the following description of the embodiments illustrated with reference to the accompanying drawings. It shows:

FIG. 1 is a schematic perspective view of a brake lining arrangement with a lining spring according to the invention in a first embodiment;

FIGS. 2a, b and c are schematic views of a lining spring according to the invention;

FIG. 3 is a partial sectional view through a brake caliper of a disc brake without brake disc with brake lining arrangements according to the invention;

FIG. 4a is a top view of a perspective view of a hold-down element according to the invention;

FIG. 4b is a below perspective view of the hold-down element according to the invention;

FIG. 5a schematically shows the relative arrangement of the two brake lining arrangements on the hold-down element;

FIG. 5b is an enlarged view of the relative arrangement of the two brake lining arrangements on the hold-down element; FIG. 6 a perspective view analogous to FIG. 1 to illustrate the forces that occur;

FIG. 7 is a perspective view of a brake lining arrangement with a lining spring according to the invention in a second embodiment; and

FIG. 8 is a sectional view of the brake lining holder plate of this embodiment.

### DETAILED DESCRIPTION OF THE PREFERRED EMBODIMENTS

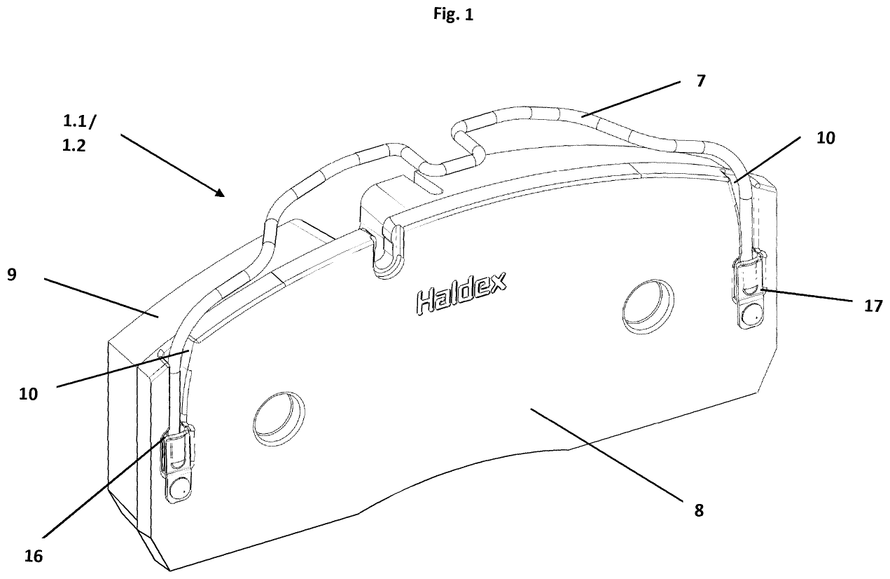

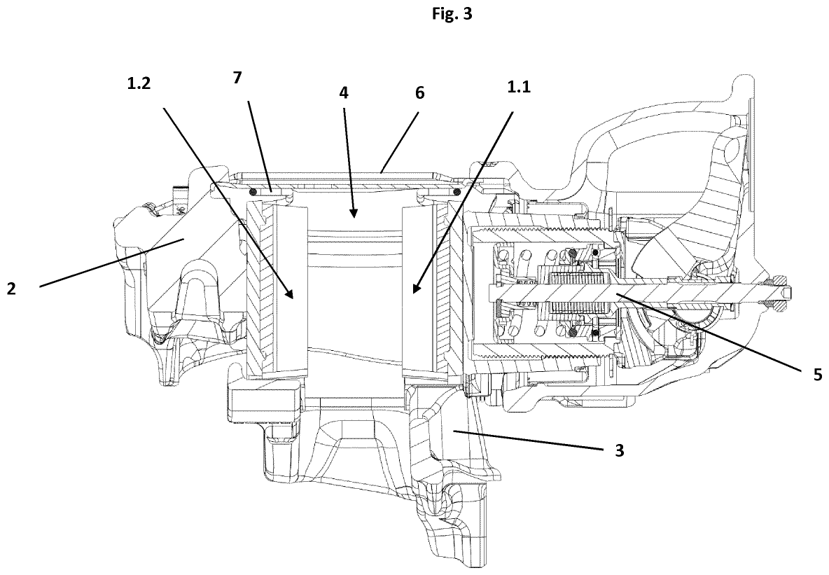

FIG. 1 shows an example of a brake lining arrangement according to the invention, which can be used both as a brake lining arrangement 1.1 on the application side and as a brake lining arrangement 1.2 on the application side in a brake caliper 2 of a disc brake, as shown in FIG. 3.

The brake caliper 2 is a sliding caliper which is slidingly guided on a caliper or brake carrier 3. In a known manner, such a disc brake has a lining slot 4 of the brake carrier 3, in which the brake lining arrangements 1.1 and 1.2 are slidingly guided in such a way that when the brake is actuated by means of a clamping device 5 located in the brake caliper 2, the brake lining arrangement 1.1 is applied to a brake disk not shown here and, when the brakes are applied as a result of the balance of forces, the application-side brake lining arrangement 1.2 is also applied to the brake disk in the opposite direction via a displacement of the brake caliper 2 sliding on the brake carrier 3. The feed direction of the brake lining arrangements 1.1 and 1.2 also defines their axial direction in the sense of the present invention.

The lining slot 4 is spanned by a retaining bracket or hold-down element 6, which can be fastened to the brake caliper 2 in a known manner and on which the brake lining arrangements 1.1 and 1.2 are each supported in a known manner by means of a lining spring 7 according to the invention.

In the embodiment shown here, the lining spring 7 is identical for the brake lining arrangement 1.1 on the application side and the brake lining arrangement 1.2 on the application side.

As shown in FIG. 1, a brake lining arrangement 1.1 or 1.2 in a first embodiment comprises a brake lining holder plate 8, on which a brake lining 9 is mounted.

Opposite the brake lining 9, the brake lining holder plate 8 has a recess 10 near each of its lateral edges, which is open towards the rear.

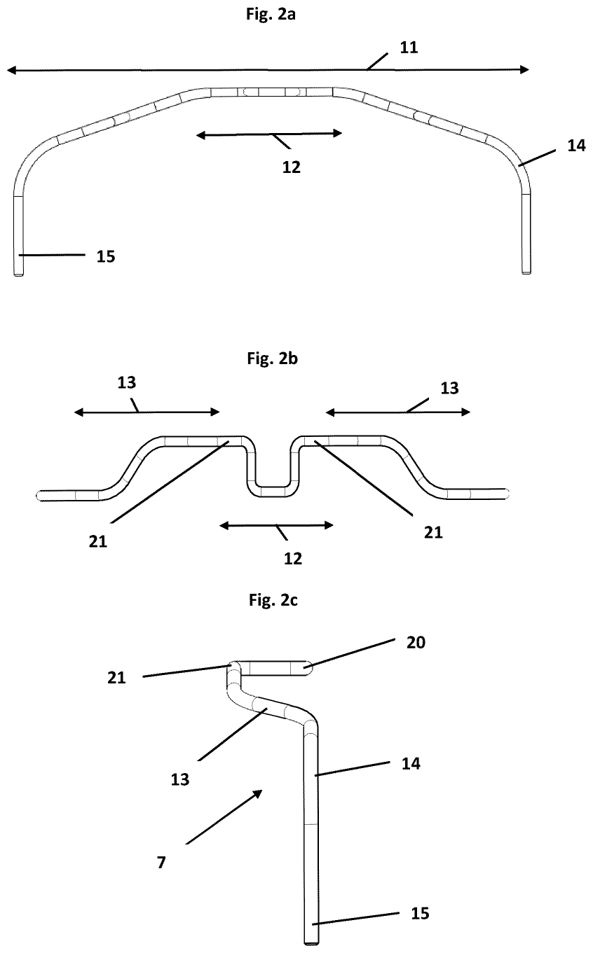

As FIGS. 2a to 2b show, the lining spring 7, which is formed or bent as a one-piece spring wire with a corresponding wire thickness, has an upper transverse area 11.

The upper transverse area 11 has a central abutment section 12 and a connecting section 13 symmetrically on either side of it.

As can be seen in FIG. 1, the two connecting sections 13 run freely, i.e., at a certain distance, above the brake lining holder plate 8 and the brake lining 9, even when the brake lining arrangement 1.1 or 1.2 is mounted.

The two connecting sections 13 each merge into two legs 14, which are aligned essentially perpendicular to the central abutment section 12 and end in free ends 15. As can be seen in FIG. 1, the legs 14 are received or guided with play in the recesses 10 and extend all the way down. The recesses 10 each have a widened section 16 at the bottom.

These extended sections 16 are used to accommodate sleeves or clips 17 or the like, which can be inserted into the extended sections 16 from the rear and riveted to the brake lining holder plate 8 so that they cannot be lost. These clips 17 form a downwardly terminating receiving space for the free ends 15, which come into contact with the base there. Alternatively, however, the free ends 15 can also come into contact directly at the base of the recess 10 and be prevented from moving backwards, against the axial direction, quasi out of the recess 10, by a substantially U-shaped clip 17.

In this embodiment, the free ends 15 of the legs 14 lie freely in the recess 10 and the clamp 17, i.e., the lining spring 7 can be easily pushed in or inserted from above and also pulled out again, and can thus be easily handled manually. The lining spring 7 is ultimately held securely by the fact that it is supported on the hold-down element 6, whereby the free ends 15 of the legs 14 exert downward compressive forces on the base of the recess 10 or the base of the riveted clamp 17, whereby the brake lining arrangement 1.1 or 1.2 as a whole is braced in the lining slot 4.

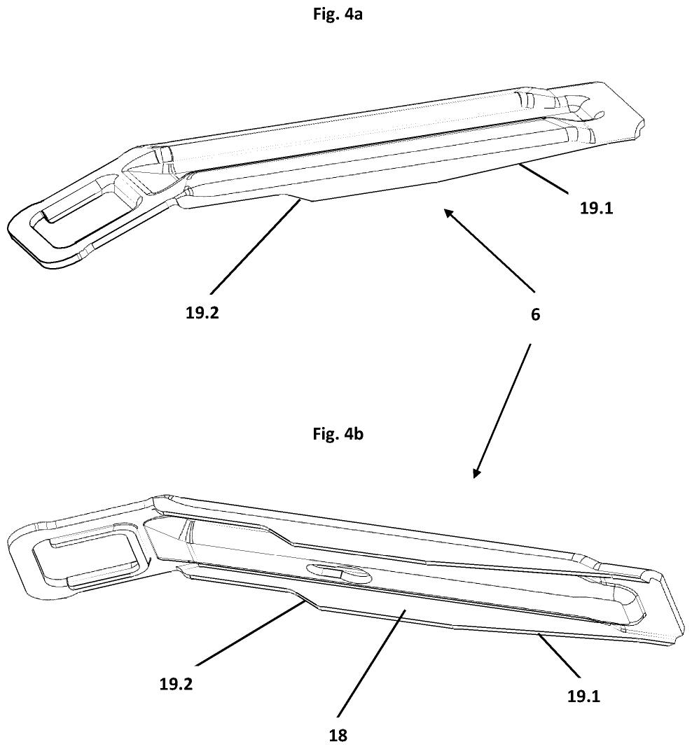

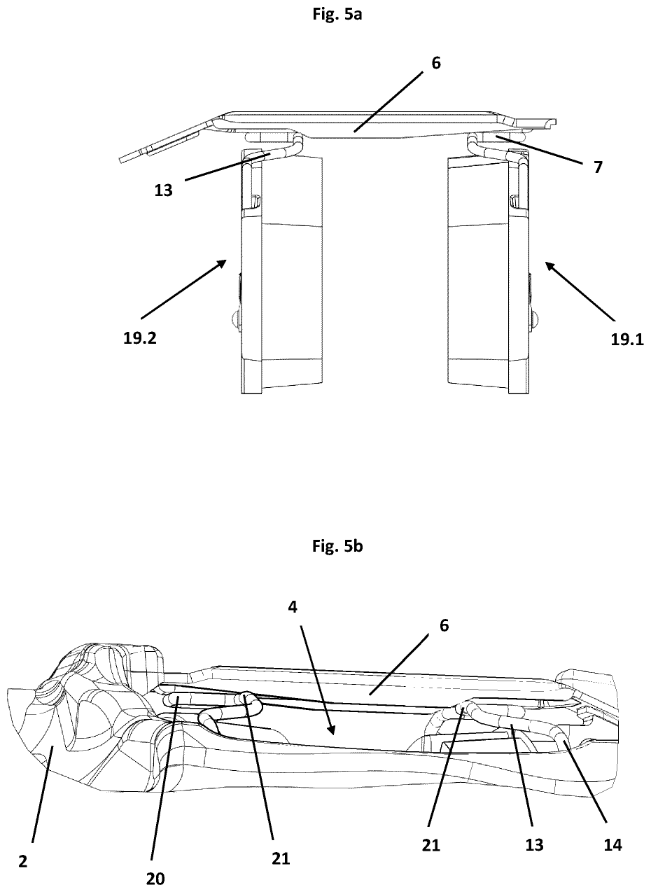

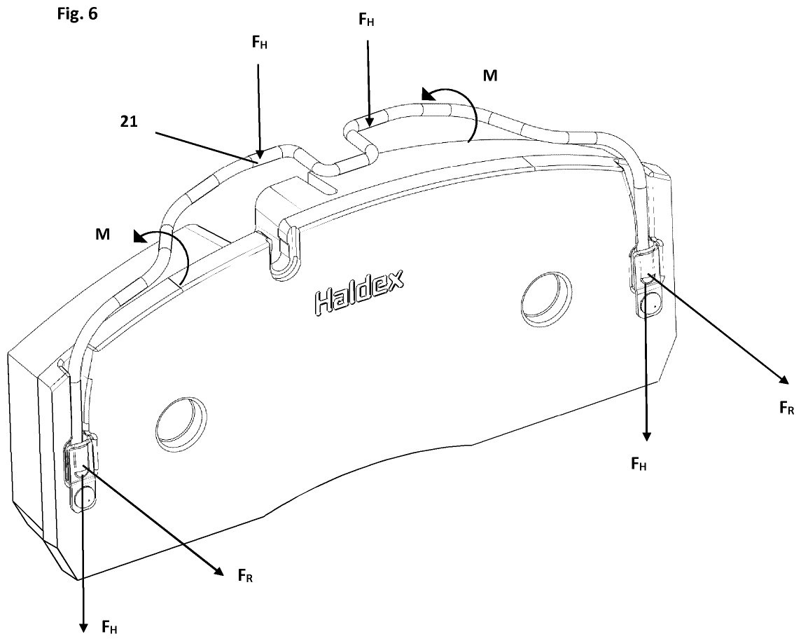

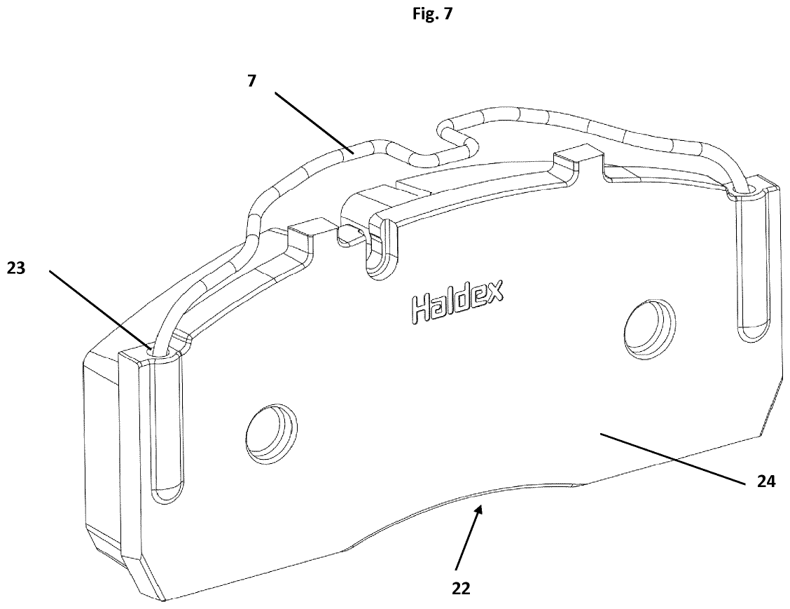

FIGS. 4a and 4b show an example of a hold-down element in the form of a retaining bracket 6, which spans the lining slot 4 and can be attached to the brake caliper 2 in a known manner (FIG. 3). The retaining bracket 6, which is usually stamped and bent from sheet metal, has an identically shaped fold or edge 18 on both sides in the longitudinal direction. The edge 18 is shaped in such a way that it has an inclined surface 19.1 on the clamping side and an inclined surface 19.2 on the application side.

The inclination of the tension-side inclination surface 19.1 is flatter than that of the application-side inclination surface 19.2.

As can be seen in FIG. 2b, the central abutment section 12 has a U-shaped section 20, the legs of which merge into a transverse section 21 on the left and right.

The lining spring 7 is designed in such a way that only these transverse sections 21 are supported on the inclination surface 19.1 on the application side and on the inclination surface 19.2 on the application side, while the U-shaped section 20 is exposed below it in relation to the retaining bracket 6.

According to the invention, the design of the lining spring 7, i.e., the three-dimensional course of the spring wire on one side and the support of its transverse sections 21 on the respective inclination surfaces 19.1. and 19.2 as well as the support of its free ends 15 in the recesses 10 on the other side, has the effect that in the assembled state, i.e., when the lining spring 7 is supported on the retaining bracket 6, forces and torques are induced in the lining spring 7, which are illustrated in FIG. 6.

Because the lining spring 7 is supported on the retaining bracket 6 via its transverse sections 21, downwardly acting compressive forces FH are exerted, which are introduced via the free ends 15 into the base of the recesses 10 or the clamps 17 and thus into the brake lining holder plate 8, whereby the latter is braced in the lining slot 4 via its corresponding sliding surfaces of the brake carrier 3.

As the free ends 15 are prevented from axial movement by the clamps 15 or a drill-like recess (see FIG. 7), compression of the lining spring 7 ultimately leads to a torque M being introduced into the exposed connecting sections 13, as these are not supported on any abutment. This torque M in turn generates an elastic torsional deformation, which is quasi intrinsic to the spring wire, and thus a leverage effect on the free ends 15 of the legs 14, the resulting force of which is expressed as a restoring force FR as soon as the brake lining arrangement is no longer applied. This restoring force FR acts on the brake lining holder plate 8 via the clamps 17 or the bore in such a way that the resetting of the brake lining arrangement 1.1 or 1.2 is supported, as the lining spring 7 is still attached to the brake lining holder plate 8 to a sufficient extent.

Since the brake lining arrangement 1.1 on the clamping side must always cover a greater distance than the brake lining arrangement 1.2 on the application side, taking into account the necessary adjustment of the lining wear over time, the inclination surface 19.1 on the clamping side is flatter. The inclination surface 19. 2 on the application side is inclined in such a way that the brake lining arrangement 1.2 on the application side is held in its position in the lining slot 4 at least in a functionally safe manner and still ensures sufficient support for resetting in relation to the smaller infeed path as a result of the relative movement of the brake caliper 2.

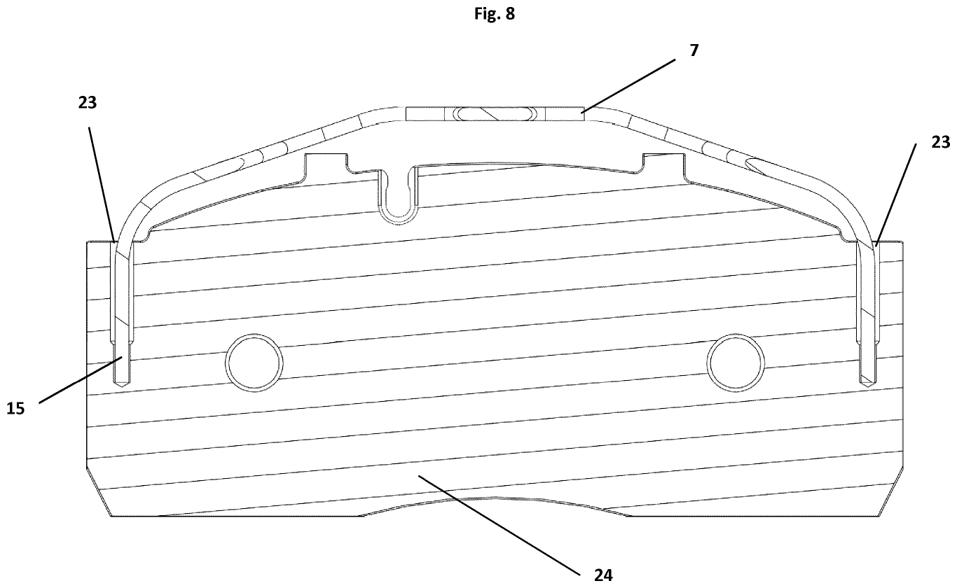

FIGS. 7 and 8 show a further embodiment of a brake lining arrangement 22 according to the invention, which can also be used on the application side or application side.

Compared to the previously described embodiment, this brake lining arrangement 22 differs in that the recess for the legs of the brake lining spring 7 is formed as a stepped hole 23, which can be made in the brake lining holder plate 24 during the casting process. The stepped hole 23 tapers in the lower section to a diameter which is provided with such tolerances in relation to the diameter of the spring wire of the free ends 15 that a slight interference fit is formed which is able to hold the lining spring 7 securely on the brake lining holder plate 24, but which can still be released manually.

1.-21. (canceled)

22. A disc brake, comprising:
a brake caliper which embraces a brake disc and is displaceably mounted on a brake carrier which has a lining slot for receiving and guiding a brake lining arrangement on a reaction side and a brake lining arrangement on an application side in an axial direction with respect to the brake disc, wherein each brake lining arrangement includes a brake lining holder plate and a brake lining arranged thereon for contact with the brake disk, with a hold-down element which is fastened to the brake caliper and engages over an opening of the lining slot transversely to the direction of rotation of the brake disk, and with a lining spring assigned to each brake lining arrangement which rests freely with its upper end against the hold-down element and is configured such that the brake lining arrangement is braced in the lining slot when the lining spring is impacted with force by the hold-down element after the brake lining has been mounted, wherein the lining spring is fixed relative to the brake lining holder plate in axial direction and is configured such that, as a result of contact with the hold-down element, an elastic torsional deformation is induced in the lining spring, at least in sections, which causes a leverage effect acting between the hold-down element and the brake lining holder plate, which is configured to reset the brake lining arrangement when the brake is released.

23. The disc brake according to claim 22, wherein the lining spring has an upper transverse region with a central abutment section, which comes to rest against the hold-down element, and on both sides thereof a connecting section extending freely above the brake lining holder plate.

24. The disc brake according to claim 23, wherein each connecting section extends into a leg which is received with a free end of the leg in a recess provided in the brake lining holder plate.

25. The disc brake according to claim 24, wherein the recess is configured such that the free ends lie freely in the recess of the leg or are received with a defined fit.

26. The disc brake according to claim 24, wherein the recesses are configured to block the free ends with respect to movement in the axial direction.

27. The disc brake according to claim 26, wherein the recesses are closed in the axial direction by a clip while receiving the free ends of the legs.

28. The disc brake according to claim 26, wherein the recesses each comprise a stepped bore in the brake lining holder plate.

29. The disc brake according to claim 23, wherein each connecting section is arranged offset at least in sections relative to the central abutment section and to the legs of the lining spring in the axial direction.

30. The disc brake according to claim 23, wherein the central abutment section has a U-shaped section, which is exposed relative to the hold-down element, and has a transverse section to the left and right of the legs of the U-shaped section, which extends into the connecting section and abuts against a respective inclination surface of the hold-down element.

31. The disc brake according to claim 30, wherein the hold-down element as two inclination surfaces which are directed towards the brake disc in opposite directions and towards the center of the opening of the lining shaft, wherein one inclination surface is assigned to the brake lining arrangement on the application side and one inclination surface is assigned to the brake lining arrangement on the reaction side such that at least one transverse section of the lining spring on the application side comes into contact with the inclination surface on the tension side and at least one transverse section of the lining spring on the application side comes into contact with the inclination sur-face on the application side.

32. The disc brake according to claim 31, wherein the inclination surface on the reaction side is steeper than the inclination surface on the application side.

33. The disc brake according to claim 31, wherein the inclination surface on the application side has such an inclination that a readjustment of the brake lining arrangement on the application side is ensured at all times.

34. The disc brake according to claim 22, wherein the lining spring comprises a one-piece spring wire.

35. A lining spring for a brake lining arrangement of a disc brake that includes a brake lining holder plate and a brake lining arranged thereon, wherein the lining spring is configured to brace the brake lining arrangement in a lining shaft of a brake carrier for a brake caliper of the disc brake, the lining spring supported in a freely bearing manner on a hold-down element which engages over an opening of the lining shaft, wherein the lining spring comprises a one-piece spring wire, and wherein the lining spring is further configured such that, as a result of contact with the hold-down element, an elastic torsional de-formation is induced in the lining spring, at least in sections, which causes a leverage effect acting between the hold-down element and the brake lining holder plate, which is configured to reset the brake lining arrangement when the brake is released.

36. The lining spring according to claim 35, wherein the lining spring has an upper transverse region with a central abutment section configured to abut against the hold-down element and, on either side thereof, a connecting section extending freely above the brake lining holder plate.

37. The lining spring according to claim 36, wherein each connecting section extends into a leg having a free end adapted to be received in a recess provided in the brake lining holder plate.

38. The lining spring according to claim 36, wherein each connecting section is arranged offset at least in sections relative to the central abutment section and to the legs in the axial direction.

39. The lining spring according to claim 36, wherein the central abutment section comprises a U-shaped section configured to be exposed with respect to the hold-down element, and left and right of the legs of the U-shaped section a transverse section configured to extend into the connecting section and to abut against a respective inclination surface of the hold-down element.

40. A brake lining arrangement, comprising:
a brake lining holder plate and a brake lining arranged thereon for a disc brake, having a lining spring according to claim 35.

41. A hold-down element for a disc brake, which is configured to span an opening of a lining shaft in the disc brake and to form an abutment for a lining spring for tensioning a brake lining arrangement on the tension side and an abutment for a lining spring for tensioning a brake lining arrangement in the lining shaft, wherein the hold-down element includes two inclination surfaces which are directed towards a brake disc in opposite directions and towards the center of the opening of the lining shaft, one inclination surface being configured to abut against at least one section of the lining spring on the application side and the other inclination surface being configured to abut against at least one section of the lining spring on the reaction side.

42. The hold-down element according to claim 41, wherein one of the inclination surfaces is steeper than the other inclination surface.

43. The hold-down element according to claim 41, wherein the two inclination surfaces are each arranged on a wall on both sides of a flat longitudinal surface of the hold-down element.
